(19) United States
(12) Patent Application Publication
(10) Pub. No.: US 2010/0295728 A1
(43) Pub. Date: Nov. 25, 2010

(54) ARRAY ANTENNA

(75) Inventor: LI CHEN, TAOYUAN (TW)

Correspondence Address: WPAT, PC;INTELLECTUAL PROPERTY ATTORNEYS, 2030 MAIN STREET, SUITE 1300, IRVINE, CA, 92614, US

(73) Assignee: MITAC INTERNATIONAL CORP., TAOYUAN (TW)

(21) Appl. No.: 12/785,513

(22) Filed: May 24, 2010

(30) Foreign Application Priority Data
May 25, 2009 (TW) 098117364

(51) Int. Cl. H04B 7/10

(52) U.S. Cl. 342/365

(57) ABSTRACT

The present invention discloses an array antenna, which comprises a first antenna, a second antenna, a phase shift unit and an impedance unit. The first antenna is arranged for receiving a satellite signal and has a first radiation field plane. The second antenna is arranged for receiving the satellite signal and has a second radiation field plane. The phase shift unit is connected to the first antenna and the second antenna, and the phase shift unit is provided for generating an orthogonal state of phase difference between the first antenna and the second antenna. The impedance unit is connected to the phase shift unit for matching the first antenna, the second antenna and the phase shift unit.

### FIELD

The present invention relates to a field of array antenna. More specifically, the present invention relates to an array antenna by using the phase shift unit to generate an orthogonal state of phase difference between the first antenna and the second antenna.

### BACKGROUND

Recently, in antenna design of the global positioning system (GPS), the signal received by the antenna in GPS terminal equipment must be the right-hand circular polarized signal because the GPS signal emitted by the satellite is a right-hand circular polarized signal. Currently, the GPS antennae usually used in the industry are the patch antennae or the four-helical antennae. Those antennae may even be provided for the better signals to the GPS terminal equipment. However, the patch antennae or the four-helical antennae having large volume and high price may result in the limitations in product design and development to the Portable Navigation Device (PND). Additionally, the design method usually used for reducing the antenna size of the patch antenna or four-helical antenna is to increase the dielectric index in materials, yet it may usually result in the phenomenon of that the quality is unstable in mass production.

### SUMMARY

According to the problems of the prior art; one purpose of the present invention is to provide an array antenna for enhancing the performance of the antenna.

According to another purpose of the present invention, an array antenna is provided. The array antenna comprises a first antenna, a second antenna, a phase shift unit and an impedance unit. The first antenna is arranged for receiving a satellite signal and has a first radiation field plane. The second antenna is arranged for receiving the satellite signal and has a second radiation filed plane. The phase shift unit is connected to the first antenna and the second antenna, and the phase shift unit is provided for generating an orthogonal state of phase difference between the first antenna and the second antenna. The impedance unit is connected to the phase shift unit for matching the first antenna, the second antenna and the phase shift unit.

The first antenna and the second antenna are selected from the group consisting of a patched inverse F antenna (PIFA), a monopole antenna, a dipole antenna, a chip antenna and the combination thereof.

The first radiation field plane and the second radiation field plane are orthogonal to each other.

The first radiation filed plane and the second radiation field plane are provided for constructing a radiation pattern of three-dimensional space.

The first antenna and the second antenna are circular polarized antennae.

The phase shift unit further connects to a chip, and the chip may be a Global Positioning System (GPS) chip.

The orthogonal state is a state having the phase difference of π/2.

The impedance unit has a resistance of 50Ω.

Above all, the array antenna of the present invention may have one or more advantages as follows:

(1) The array antenna may be provided for an antenna design of small size, low cost, and high performance.

(2) The array antenna may be selected form the group consisting of a Patched Inverse F Antenna (PIFA), a monopole antenna, a dipole antenna, a chip antenna and the combination thereof.

With these and other objects, advantages, and features of the invention that may become hereinafter apparent, the nature of the invention may be more clearly understood by reference to the detailed description of the invention, the embodiments and to the several drawings herein.

### BRIEF DESCRIPTION OF THE DRAWINGS

The exemplary embodiment(s) of the present invention will be understood more fully from the detailed description given below and from the accompanying drawings of various embodiments of the invention, which, however, should not be taken to limit the invention to the specific embodiments, but are for explanation and understanding only.

FIG. 1 illustrates a schematic diagram of the array antenna of the present invention;

FIG. 2 illustrates a field pattern of the first antenna of the array antenna in accordance with one embodiment of the present invention;

FIG. 3 illustrates a field pattern of the second antenna of the array antenna in accordance with one embodiment of the present invention;

FIG. 4 illustrates a return loss schematic diagram of the array antenna in accordance with one embodiment of the present invention;

FIG. 5 illustrates a flow chart of manufacturing method of the array antenna of the present invention; and

FIG. 6 illustrates a quantitative relationship diagram of time to first fix for the patch antenna, the first antenna and the second antenna.

### DETAILED DESCRIPTION

Exemplary embodiments of the present invention are described herein in the context of an array antenna by using the phase shift unit to generate an orthogonal state of phase difference between the first antenna and the second antenna.

Those of ordinary skilled in the art will realize that the following detailed description of the exemplary embodiment(s) is illustrative only and is not intended to be in any way limiting. Other embodiments will readily suggest themselves to such skilled persons having the benefit of this disclosure. Reference will now be made in detail to implementations of the exemplary embodiment(s) as illustrated in the accompanying drawings. The same reference indicators will be used throughout the drawings and the following detailed description to refer to the same or like parts.

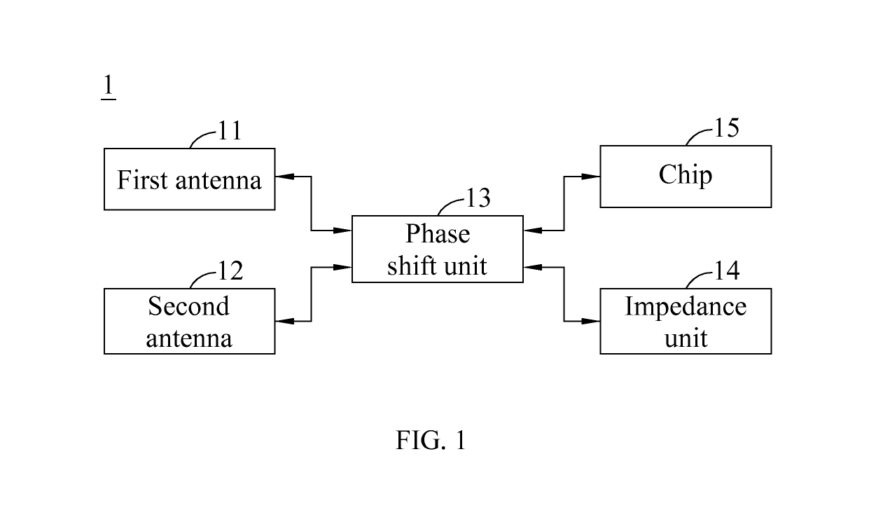

Please refer to FIG. 1, which illustrates a schematic diagram of the array antenna of the present invention. In the figure, the array antenna 1 comprises a first antenna 11, a second antenna 12, a phase shift unit 13 and an impedance unit 14. The first antenna 11 is arranged for receiving a satellite signal and has a first radiation field plane. The second antenna 12 is also arranged for receiving the satellite signal and the second antenna 12 has a second radiation field plane. The first antenna 11 and the second antenna 12 may be a main antenna and an auxiliary antenna respectively, and are provided for constructing a radiation pattern of three-dimensional space. For example, when the radiation field of the main antenna is on the YZ plane, the radiation field of the auxiliary antenna may be located on the XZ plane. It is not limited to the condition that is described above. The radiation field of the auxiliary antenna may be located on the XY plane. It is always satisfied with the situation that those two planes are orthogonal to each other. The directional characteristic of the antenna may be understood by obtaining the radiation fields of two orthogonal planes. When the antenna has a strong electromagnetic field characteristic in a specific direction more than the other direction, the antenna may be called as a directional antenna. The meaning of the direction to the radiation source of the electromagnetic field may be defined as the ratio of the maximum radiation intensity to the average radiation intensity, as shown in equation (1).

Direction(D)=Maximum radiation intensity/Average radiation intensity (1)

The first antenna 11 and the second antenna 12 are selected from the group consisting of a Patched Inverse F Antenna (PIFA), a monopole antenna, a dipole antenna, a chip antenna and the combination thereof. It is not limited to the condition which is described above. In addition, the first antenna 11 and the second antenna 12 are the circular polarized antennae. Herein, the circular polarized antennae comprise left-hand circular polarized antennae or right-hand circular polarized antennae.

The phase shift unit 13 is connected to the first antenna 11 and the second antenna 12, and the phase shift unit 13 is provided for generating an orthogonal state of phase difference between the first antenna 11 and the second antenna 12. Herein, the orthogonal state is a state having the phase difference of π/2, and the phase shift unit 13 may be a phase shifter. When the phase shifter is connected to the first antenna 11 and the second antenna 12, and the first antenna 11 and the second antenna 12 are the circular polarized antennae, the phase difference of π/2 between the first antenna 11 and the second antenna 12 may be generated through the phase shifter. The phase shift unit 13 further connects to a chip, and the chip may be a Global Positioning System (GPS) chip. The GPS system comprises 24 GPS satellites in space, the user's position and the altitude on the earth can be located through four of the satellites. The more satellites have been received, the more precise position decoded by the GPS system will be obtained.

The impedance unit 14 is connected to the phase shift unit 13 for impedance matching among the first antenna 11, the second antenna 12 and the phase shift unit 13. The impedance unit 14 has a resistance of 50Ω. The power of the signals received by the first antenna 11 and the second antenna 12 may be transferred more effectively from the signal source to the load. In other words, the phenomenon that the signals are reflected in the transmitting process may not happen.

Therefore, when the array antenna 1 is applied to GPS, the satellite signals received by the first antenna 11 and the second antenna 12 respectively may be shifted to 90 degrees through the phase shift unit 13. From which, the Time to First Fix (TTFF) may be shortened, and the user needs not to pay much time to wait the GAS system for positioning.

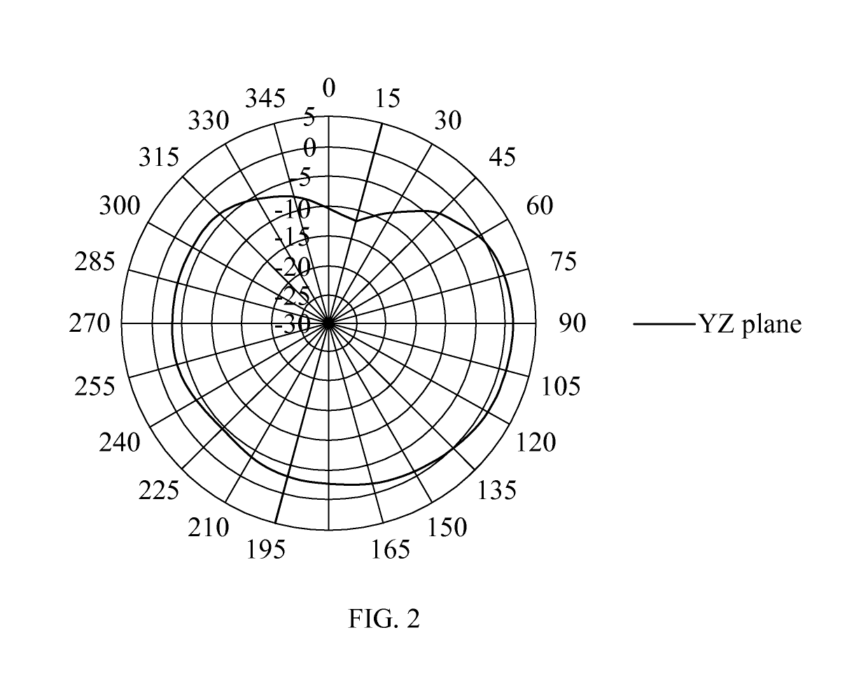

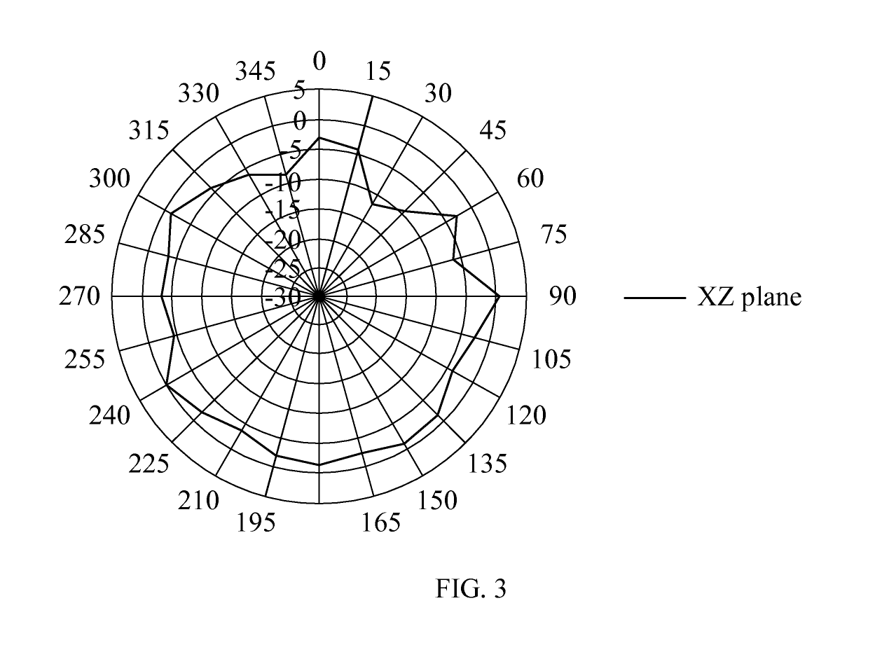

FIG. 2 illustrates a field pattern of the first antenna of the array antenna in accordance with one embodiment of the present invention. FIG. 3 illustrates a field pattern of the second antenna of the array antenna in accordance with one embodiment of the present invention. When the satellite signals are received by the first antenna 11 and the second antenna 12, a radiation field pattern may be obtained and the direction of the antenna may be understood through the radiation field pattern. FIG. 2 is the radiation field diagram of the first antenna 11 on the YZ plane. FIG. 3 is the radiation field diagram of the second antenna 12 on the XZ plane. The first antenna 11 and the second antenna 12 do not have a strong electromagnetic field characteristic in a specific direction more than other direction. In other words, those two antennae are the omni-directional antennae.

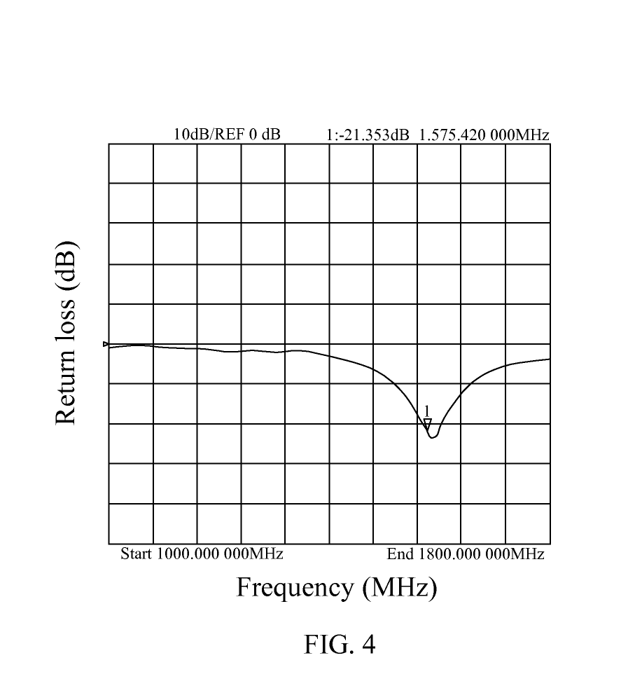

FIG. 4 illustrates a return loss schematic diagram of the array antenna in accordance with one embodiment of the present invention. The meaning of the return loss is defined as the impedance matching level between the signal source and the load. When the return loss is greater, the matching level in circuit is better. In contrast, when the return loss is zero, the circuit of the load is an open circuit or the short circuit and the impedance is completely mismatching. The input signals are completely reflected to the input end. The standing waves may be formed when the signals are generated to reflect in the transmitting cable. The standing waves will be more obvious when a large number of the signals are reflected. The standing waves may be a noise source and the standing waves may reduce the transmitting efficiency of the signals to the load. Therefore, decreasing the standing waves may provide the high quality of the signals and enhance the transmitting efficiency of the signals. Additionally, in the circuit theory, when the impedance matches, the output power of the signal is the maximum. The level of the impedance matching is an important technique to increase the efficiency of the amplifier. It will be more effectively to understand whether the impedance matching is better or not by observing the amount of the return loss or the standing wave. In the figure, the X coordinate represents the frequency, and the frequency has a range from 1000 Mhz to 1800 Mhz. When the frequency is 1575.42 Mhz, the return loss is −21.353 dB.

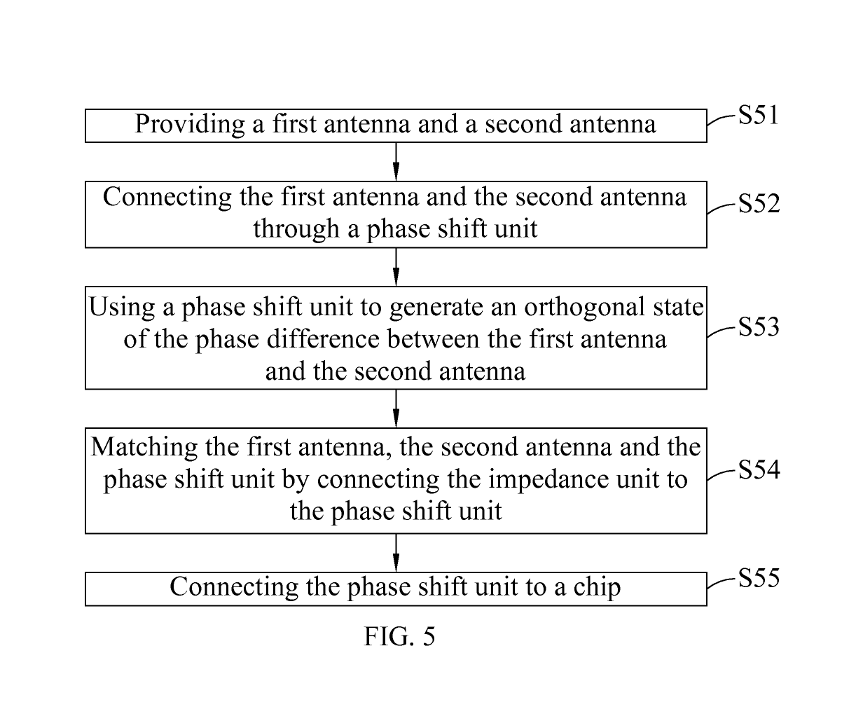

FIG. 5 illustrates a flow chart of manufacturing method of the array antenna of the present invention. In the figure, the manufacturing method of the array antenna comprises the following steps. In step S51, a first antenna and a second antenna are provided. Herein, the first antenna and the second antenna are selected from the group consisting of a Patched Inverse F Antenna (PIFA), a monopole antenna, a dipole antenna, a chip antenna and the combination thereof. The first antenna and the second antenna are circular polarized antennae and the circular polarized antennae are left-hand circular polarized antennae or right-hand circular polarized antennae. In step S52, the first antenna and the second antenna are connected through the phase shift unit. In step S53, an orthogonal state of the phase difference is generated between the first antenna and the second antenna by the phase shift unit, The orthogonal state is a state having the phase difference of it π/2. In step 54, the impedance unit is connected to the phase shift unit for impedance matching among the first antenna, the second antenna and the phase shift unit. The impedance unit may have a resistance of 50Ω. The manufacturing method of the array antenna further comprises the step of S55. In S55, the phase shift unit further connects to a chip, and the chip may be a GPS chip.

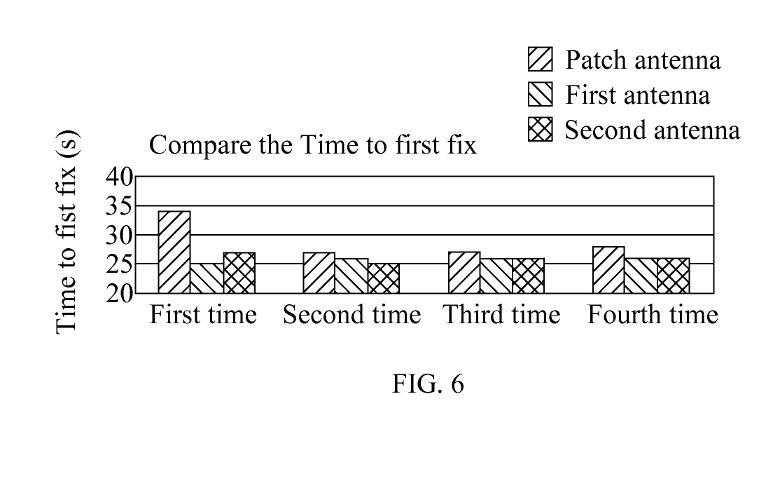

Table 1 is the comparison table of the Time To First Fix (TIFF) for the patch antenna, the first antenna and the second antenna. FIG. 6 illustrates a quantitative relationship diagram of the Time To First Fix (TTFF) for the patch antenna, the first antenna and the second antenna. It may be figured out the searching time of the array antenna composed of the first antenna and the second antenna is shorter than that of the patch antenna of the prior art by sampling fourth times to obtain the average value of the searching time. Therefore, the array antenna of the present invention is better than the patch antenna of the prior art.

Table 1 is the comparison table of Time To First Fix (TTFF) for the patch antenna, the first antenna and the second antenna

| | Patch antenna | First antenna | Second antenna |
|---|---|---|---|
| First time | 34 s | 25 s | 27 s |
| Second time | 27 s | 26 s | 25 s |
| Third time | 27 s | 26 s | 26 s |
| Fourth time | 28 s | 26 s | 26 s |
| Average value | 29 s | 25.75 s | 26 s |

While particular embodiments of the present invention have been shown and described, it will be obvious to those skilled in the art that, based upon the teachings herein, changes and modifications may be made without departing from this invention and its broader aspects. Therefore, the appended claims are intended to encompass within their scope of all such changes and modifications as are within the true spirit and scope of the exemplary embodiment(s) of the present invention.

What is claimed is:

1. An array antenna, comprising:
a first antenna arranged for receiving a satellite signal and having a first radiation field plane;
a second antenna arranged for receiving the satellite signal and having a second radiation field plane;
a phase shift unit being connected to the first antenna and the second antenna, and the phase shift unit being provided for generating an orthogonal state of phase difference between the first antenna and the second antenna; and
an impedance unit being connected to the phase shift unit for matching the first antenna, the second antenna and the phase shift unit.

2. The array antenna of claim 1, wherein the first antenna and the second antenna are selected from the group consisting of a Patched Inverse F Antenna (PIFA), a monopole antenna, a dipole antenna, a chip antenna and the combination thereof.

3. The array antenna of claim 1, wherein the first radiation field plane and the second radiation field plane are orthogonal to each other.

4. The array antenna of claim 1, wherein the first radiation field plane and the second radiation field plane are provided for constructing a radiation pattern of three-dimensional space.

5. The array antenna of claim 1, wherein the first antenna and the second antenna are circular polarized antennae.

6. The array antenna, of claim 5, wherein the circularly polarized antennae are left-hand circular polarized antennae.

7. The array antenna of claim 5, wherein the circularly polarized antennae are right-hand circular polarized antennae.

8. The array antenna of claim 1, wherein the phase shift unit further connects to a chip.

9. The array antenna of the claim 8, wherein the chip is a Global Positioning System (GPS) chip.

10. The array antenna of the claim 1, where the orthogonal state is a state having the phase difference of it π/2.

11. The array antenna of claim 1, wherein the impedance unit has a resistance of 50Ω.
